(19) United States
(12) Patent Application Publication
(10) Pub. No.: US 2007/0115677 A1
(43) Pub. Date: May 24, 2007

(54) Double headlight for vehicles

(75) Inventor: Nader Faghihzadeh, Freising (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/654,014

(22) Filed: Jan. 17, 2007

Related U.S. Application Data
(63) Continuation of application No. PCT/EP05/06040, filed on Jun. 6, 2005.

(30) Foreign Application Priority Data
Jul. 27, 2004 (DE) 10 2004 036 413.3

(51) Int. Cl. F21V 9/00

(52) U.S. Cl. 362/511; 362/507

(57) ABSTRACT

A double headlight for vehicles is provided, including two light units adjacently arranged in a housing, each with a light source arranged in a reflector and a light guide element, arranged in front of the light unit, and at least partly enclosing the same, perpendicular to the irradiation direction thereof. The light units are adjacently arranged, transverse to a vehicle longitudinal axis and offset relative to each other, parallel to the vehicle longitudinal axis. The light units extend into a common open housing chamber in the irradiation direction, the light guide elements being arranged parallel to the vehicle longitudinal axis for each light unit at a clear separation from each other.

### CROSS REFERENCE TO RELATED APPLICATIONS

This application is a continuation of PCT International Application No. PCT/EP2005/006040, filed Jun. 6, 2005, which claims priority under 35 U.S.C. § 119 to German Patent Application No. 10 2004 036 413.3 filed Jul. 27, 2004, the entire disclosures of which are herein expressly incorporated by reference.

### BACKGROUND AND SUMMARY OF THE INVENTION

The present invention relates to a double headlight for vehicles, including two light units adjacently located in a housing. Each of the light units includes a light source provided in a reflector and a light guide element, located in front of the light unit and at least partly enclosing the light unit, transverse to the irradiation direction thereof. The light units are adjacently located transverse to a vehicle longitudinal axis, and are offset relative to one another, parallel to the vehicle longitudinal axis.

A double headlight for vehicles is known from German patent document DE 100 40 302 A1, which discloses a double headlight having two light units, i.e., headlights, adjacently located in a housing. Located in front of each of the headlights is an annular light element as part of a signal light. Double headlights disclosed by German patent documents DE 101 14 123 A1 and DE 102 51 812 A1 have the same design.

A disadvantage of the known double headlights is that the signal lights, i.e., the light guide elements, are each directly associated with a reflector or at least one cover element. The three-dimensional appearance and the esthetic design of such a double headlight are thereby undesirably restricted.

An object of the present invention, therefore, is to improve known double headlights by improving the three-dimensional design thereof.

This object is achieved by providing a double headlight including two light units according to the present invention, in which the light units project into a common open housing chamber in the irradiation direction, wherein light guide elements of the light units are parallel to the vehicle longitudinal axis for each light unit at a clear separation from one another.

The clear separation of the light guide elements results in a distinctive signal light having an efficient design. When only the signal light is turned on, the signal light clearly stands out from the darker housing chamber to the rear, and appears to “float,” i.e., project into space. The open arrangement of the light guide elements also results in a three-dimensional effect which is manifested, for example, at an oblique viewing angle in an apparent overlapping of the adjacent light guide elements.

According to one exemplary embodiment of the invention, the light guide element is designed as a light ring. The light ring may be open at the top. In principle, the light guide element may also have an elliptical, kidney, or rectangular shape. In the light ring which is open at the top, the ends of the light ring lead out to the rear in the direction opposite the irradiation direction, thus allowing light to be injected through the ends of the light ring. The light guide elements have an irradiation surface in the irradiation direction by means of which injected light may be radiated. At least a portion of the rear surface of the light guide elements have a reflective design facing away from the irradiation surface.

According to another embodiment of the invention, the light units are designed as projection modules, which have a light source provided in a reflector. In front of the reflector and light source, a lens is located which is secured in a cover connected to the reflector by lateral bars. As a result of the design as projection modules, the light units have a relatively small diameter, so that in the front view a distance results with respect to the light guide elements designed as light rings. At the same time, this further reinforces the three-dimensional effect of the light guide elements with respect to the light units.

According to another exemplary embodiment of the invention, in the vertical direction, the light elements are held at the bottom by one retaining element and at the top by two retaining elements. This creates a secure three-point bearing for the light guide elements without detracting from the three-dimensional effect.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 shows a three-dimensional illustration of a left double headlight of a motor vehicle, in an elevation viewed obliquely from the front;

FIG. 2 shows a side view of the double headlight from FIG. 1, in a section along the line II-II;

FIG. 3 shows a top view of a right double headlight without a housing;

FIG. 4 shows a front view of the double headlight from FIG. 3; and

FIG. 5 shows a side view of the double headlight from FIG. 3, viewed from direction V.

### DETAILED DESCRIPTION OF THE DRAWINGS

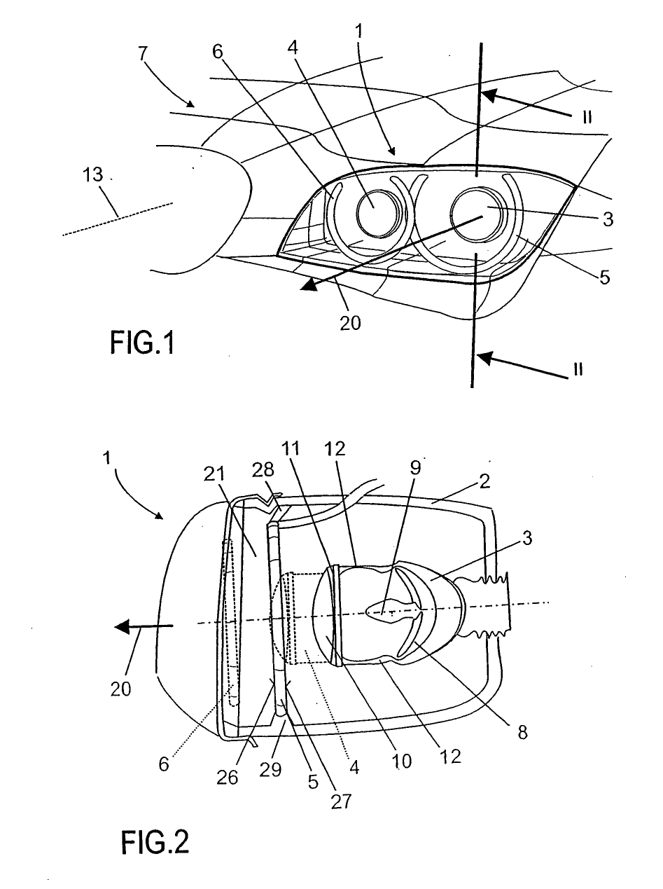

As illustrated in FIG. 1, a double headlight 1 may include a housing 2, two light units 3, 4, and two light guide elements 5, 6.

The double headlights 1 together with their housings 2 are inserted into corresponding receiving openings in a motor vehicle 7 (see FIG. 1).

The light units 3, 4 include a reflector 8 having a centrally positioned light source 9, and a reflector 8 and a lens 10 located in front of a light source 9. The lens 10 is supported in a cover 11, which is connected to the reflector 8 by lateral bars 12 (see FIG. 2). The light units 3, 4 are adjacently located at a distance 14 from one another, transverse to a vehicle longitudinal axis 13. The light units 3, 4 are offset relative to one another at a distance 15 from one another, parallel to the vehicle longitudinal axis 13. The light guide elements 5, 6 are situated in front of the light units 3, 4. The light guide element 5 has a clear separation 16 with respect to the light unit 3, parallel to the vehicle longitudinal axis 13, and the light guide element 6 has a clear separation 17 with respect to the light unit 4. The light guide elements 5, 6 have a clear longitudinal separation 18 with respect to one another, parallel to the vehicle longitudinal axis 13. Transverse to the vehicle longitudinal axis 13, the light guide elements 5, 6 have a clear transverse separation 19 with respect to one another. The light units 3, 4 project in the irradiation direction 20 into an open housing chamber 21 for the housing 1, so that the light guide elements 5, 6 are positioned in the housing chamber 21 in front of the light units 3, 4 with free clearance. In this context, “free clearance” primarily means that the light guide elements are not embedded in reflectors, covers, or dimming or visual protection elements.

The light guide elements 5, 6 are designed as light rings that are open at the top, in the vertical direction. According to the exemplary embodiment, the two upper ends of the light guide elements 5, 6, i.e., the light rings, are oppositely located with respect to the irradiation direction 20 and lead out to the rear, with light being injected via the two ends. Of course, the light may also be injected by specialized light injection elements, etc.

The light guide elements 5, 6 have an irradiation surface 26 in the irradiation direction 20, from which injected light may be radiated. The light guide elements 5, 6 have a reflective design, at least in places, at their rear surface facing 27 away from the irradiation surface 26.

The light elements 5, 6 are held at the top by two retaining elements 28, and in the vertical direction are held at the bottom by one lower retaining element 29.

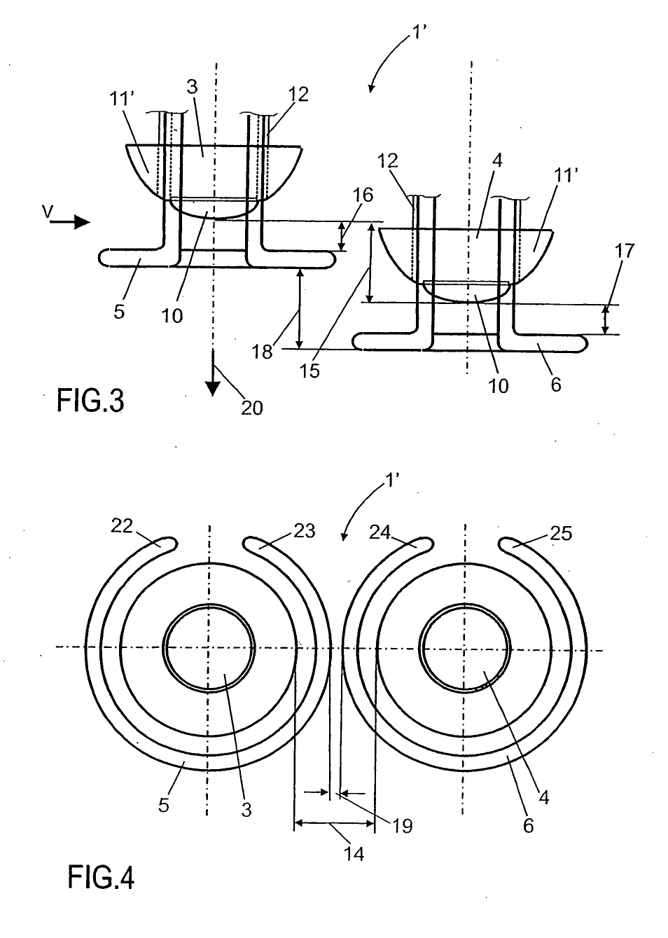

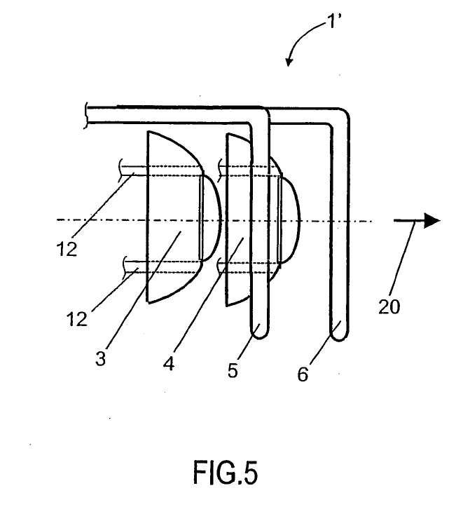

FIGS. 3 through 5 illustrate a right double headlight 1′, whose design in principle corresponds to the mirror image of the double headlight 1 of FIGS. 1 and 2. The cover 11′ has a larger diameter than the cover 11, and at the same time represents a type of visual protection. Depending on the viewing angle of an observer, not illustrated, the light elements of the double headlights appear to overlap, i.e., to be adjacently located at a distance. When the light guide elements 5, 6 are illuminated in front of a dark background, they produce a “floating,” i.e., three-dimensional, effect. The light unit 3, 4 when brightly illuminated appears to float, i.e., project in space, relative to the light guide elements 5, 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A double headlight for a vehicle, comprising:
two light units located adjacently to each other in a housing, each including a light source provided in a reflector and a light guide element, the light guide elements located in front of the light units, and at least partly enclosing the light units transverse to the irradiation direction thereof;
wherein the light units are adjacently located transverse to a vehicle longitudinal axis, and are offset relative to one another, parallel to the vehicle longitudinal axis;
wherein the light units project into a common open housing chamber in the irradiation direction; and
wherein the light guide elements are parallel to the vehicle longitudinal axis for each light unit at a clear separation from one another.

2. The double headlight according to claim 1, wherein each of the light guide elements is configured as a light ring.

3. The double headlight according to claim 2, wherein each of the light rings is open at its top, in the vertical direction.

4. The double headlight according to claim 3, wherein the two upper ends of each of the light rings lead out to the rear of the light units in the direction opposite the irradiation direction and light may be injected through the two upper ends of each of the light rings.

5. The double headlight according to claim 1, wherein the light guide elements have an irradiation surface in the irradiation direction from which injected light may be radiated, and at least a portion of the light guide elements are reflective at a rear surface thereof facing away from the irradiation surface.

6. The double headlight according to claim 5, wherein at least one of the light units has a lens located in front of a reflector and a light source.

7. The double headlight according to claim 6, wherein the light units are configured as projection modules each having the lens secured in a cover connected to the reflector by lateral bars.

8. The double headlight according to claim 1, wherein, in the vertical direction, the light guide elements are held at the bottom and top by at least one retaining element.

9. The double headlight according to claim 8, wherein the light guide elements are held at the top by two retaining elements and at the bottom by one retaining element.

10. The double headlight according to claim 2, wherein the light guide elements have an irradiation surface in the irradiation direction from which injected light may be radiated, and at least a portion of the light guide elements are reflective at a rear surface thereof facing away from the irradiation surface.

11. The double headlight according to claim 3, wherein the light guide elements have an irradiation surface in the irradiation direction from which injected light may be radiated, and at least a portion of the light guide elements are reflective at a rear surface thereof facing away from the irradiation surface.

12. The double headlight according to claim 4, wherein the light guide elements have an irradiation surface in the irradiation direction from which injected light may be radiated, and at least a portion of the light guide elements are reflective at a rear surface thereof facing away from the irradiation surface.

13. The double headlight according to claim 10, wherein at least one of the light units has a lens located in front of a reflector and a light source.

14. The double headlight according to claim 11, wherein at least one of the light units has a lens located in front of a reflector and a light source.

15. The double headlight according to claim 12, wherein at least one of the light units has a lens located in front of a reflector and a light source.

16. The double headlight according to claim 2, wherein in the vertical direction, the light guide elements are held at the bottom and top by at least one retaining element.

17. The double headlight according to claim 3, wherein in the vertical direction, the light guide elements are held at the bottom and top by at least one retaining element.

18. The double headlight according to claim 4, wherein in the vertical direction, the light guide elements are held at the bottom and top by at least one retaining element.

19. The double headlight according to claim 5, wherein in the vertical direction, the light guide elements are held at the bottom and top by at least one retaining element.

20. A double headlight, comprising:
two light units disposed adjacently to each other in a parallel, offset arrangement relative to each other, each of the light units including
a light source provided in a reflector; and
a light guide element, the light guide elements disposed separately from each other and parallel to each other in front of the light units, and at least partly enclosing the light units transverse to the irradiation direction thereof; and
a common open housing chamber, in which the light units project in the irradiation direction thereof.
